(19) United States
(12) Patent Application Publication
(10) Pub. No.: US 2003/0046098 A1
(43) Pub. Date: Mar. 6, 2003

(54) Apparatus and method that modifies the ranking of the search results by the number of votes cast by end-users and advertisers

(76) Inventor: Seong-Gon Kim, Livermore, CA (US)

Correspondence Address: Mark C. Pickering, PILLSBURY WINTHROP LLP, 50 Fremont Street, 5th Floor, San Francisco, CA, 94105-2230, US

(21) Appl. No.: 09/947,557

(22) Filed: Sep. 6, 2001

(51) Int. Cl. G06F 17/60; G06G 7/00; G06F 17/00

(52) U.S. Cl. 705/1; 705/400

(57) ABSTRACT

A voting system modifies the ranking of the results obtained by a keyword search by combining the ranking obtained using objective relevancy analysis with a number of free and paid votes cast by end-users and advertisers. The system combines objective algorithmic ranking of Web sites with the endorsement or disapproval by the general public of the Internet search engine users (end-users) and the promotional efforts by the advertisers expressed in the form of voting. The users of the present invention, either general users or advertisers, can cast their votes, paid or free, for the URLs of their choices for certain queries to promote the ranking of the targeted URLs. Furthermore, the general users can cast free disapproval votes to express their disapproval for the sites they find less helpful.

### BACKGROUND OF THE INVENTION

1. Field of the Invention

The present invention relates to an apparatus and method that searches and lists Internet sites, especially the Web, in response to queries. In particular, the present invention relates to an apparatus and method that modifies the ranking of the search results by combining the rank assigned from an objective relevancy analysis with the number of votes cast by end-users and advertisers.

2. Description of the Related Art

The World Wide Web (Web) is a rapidly growing part of the Internet. All resources on the Web, termed pages or documents, are identified by an address, termed a URL (Uniform Resource Locator). A study conducted by Cyveillance, “Sizing the Internet”, in July, 2000, found that the Internet is growing at an explosive rate of more than seven million Web pages each day and indicating that there are more than two billion publicly available Web pages by early 2001.

When this kind of unprecedented growth is combined with one of the most prominent features of the Internet, the lack of a central organization, the result is an ocean of uncharted Web pages. Finding relevant information on the Web has become an increasingly challenging task that leaves millions of Internet users frustrated everyday.

Recently, Web search engines have emerged as one of the most important means of information retrieval on the Web. According to the Search Engine Index maintained by Search Engine Watch (www.searchenginewatch.com), 46% of Internet users find new web sites via search engines compared to the next most popular methods, word of mouth (20%) and random searching (20%).

A survey done by RealNames in April 2000 found that more than 75% of Web users use search engines to traverse the Web. According to the study done by Statistical Research, Inc. (SRI) in February 2000, 57% of Internet users search the Web each day, making search the second most popular Internet activity behind the most popular activity, email, with 81% of users checking each day. The Consumer Daily Question Study conducted in the Fall of 2000 found that search engines are the top information resource Americans use when seeking answers, used 32 percent of time, more than any other option.

There are two different types of search engines: Web directory search engines and crawler-based search engines. Directory search engines typically use a hierarchy of categories and subcategories. Web pages are then assigned to a particular category depending on a specific classification approach.

For example, Yahoo! utilizes a hierarchy of categories, such as Computer & Internet and Education. A user chooses a category, then successive subcategories that seem likely to lead the user to the information sought. Web directories traditionally rely on specially trained human classifiers. This approach, however, requires too much skilled manpower.

By late-1999, Yahoo! reported indexing more than 1.2 million Web pages, but this is relatively small compared to the Web. In late 1999, Yahoo! had about 100 editors compiling and categorizing Web sites. However, even if this number of editors greatly increases, Yahoo! is not expected to be able to cover the entire Web.

Moreover, manual categorization is too slow to keep a Web directory up to date with an ever-evolving Web. New documents are created, and old ones removed or changed. New categories emerge, and old ones fade away or take up new or additional meanings. Thus, one of the big disadvantages of Web directories is the narrow and dated coverage that is provided.

Crawler-based search engines are the other important means of information retrieval on the Web. The WISEnut search engine, for example, has substantial coverage of the Web, indexing close to a billion Web pages. Pending U.S. patent application Ser. No. 09/757,435 filed on Feb. 8, 2001 in the name of B. S. Kim et al., which is hereby incorporated by reference, describes the WISEnut search engine and its ranking algorithm.

Using automated downloading agents, known as crawlers or robots, these search engines systematically search and download the content of a substantial portion of Internet. These Web pages are parsed and indexed into tables of keywords and the list of Web pages containing them. Later when a user performs a search or query, the search engine combines these tables to generate the intersection of the list of Web pages pertinent to the search terms.

Thus, unlike the traditional Web directories that require many human editors, a crawler-based search engine can collect and index a substantial portion of the Web with no or little human intervention. Crawler-based search engines are also the only viable solution to keep up with the explosive growth rate of the Web.

However, as crawler-based search engines increase their coverage, they exacerbate an existing problem, that being an overload of information. Search engines pull up all Web pages meeting the search criteria, which can overwhelm a user with thousands of irrelevant pages. In addition, under-specified search terms—in some cases the user does not know exactly what information is desired and tends to submit very general and under specified queries—can produce thousands or even millions of irrelevant or only marginally relevant pages.

Once the Web pages are identified, the user must review them one Web page at a time to find the relevant ones. Even if the user could download many pages, average users are not always willing to take a look at more than a display of pages. Therefore, it is important to present the search results in such a way that helps the user easily browse the search results. Many search engines employ a very sophisticated ranking algorithm to determine the relative relevancy of the pages and rank them in the order of relevancy.

The WISEnut search engine, for example, uses so-called context sensitive link analysis to make a very objective judgment on the relative relevancy of the pages. The WISEnut search engine also offers another important feature to help users quickly and easily find the document they want. The feature, named WlSEguide, automatically categorizes the documents in the search results.

Pending U.S. patent application Ser. No. 09/844,040 filed on Apr. 27, 2001 in the name of B. S. Kim et al., which is hereby incorporated by reference, describes this automatic categorization feature. The WlSEguide combines the benefits of the directory search engines (without the need for large numbers of skilled human classifiers) with the speed and coverage of crawler-based search engines.

With the importance of Internet searches growing rapidly, the market potential for Internet searching is tremendous. Many webmasters are allocating substantial amounts of financial and human resources to improve the ranking of their websites on popular search engines. A study done by Direct Marketing Association in August 2000 found that search engine positioning was the top method cited by website marketers to drive traffic to their sites (66%), followed by email marketing (54%).

In addition, there are many companies claiming that they practice the black magic of search engine optimization, and that they can place the websites of their clients in highly ranked slots. A study conducted by Iconocast in November 2000, “Search Engine Optimization”, found that there are more than 250 companies professing such claims.

Many of the search engines, however, use proprietary algorithms to rank the relevancy of the Web pages, and one method that works well for one particular search engine may actually degrade its ranking on another search engine. Furthermore, new breeds of search engines, such as the WISEnut search engine, use very objective and sophisticated link analysis that considers and analyzes the global link structure of the entire Web.

Thus, the ranking on this kind of search engine cannot be easily manipulated by adding some meta-tags or creating a limited number of favorable links. And despite of their claims, these “optimization” techniques do rarely achieve their promised results. Even when these practices do work for less sophisticated search engines, the improvement occurs too slowly to satisfy the needs of the Web site marketers.

Recently, some search engines have started to offer a so-called Pay-To-Placement service. An example of this type of system is described in U.S. Pat. No. 6,078,866 in the name of B. J. Buck et al. These systems allow the Web sites to pay money to increase their rank in the results of a given search. To make a website the top result for a particular search, the only thing to do is to pay more money than anyone else.

With the Pay-To-Placement service, webmasters no longer need to worry about the black magic of search engine optimization. The process is transparent and the effect is immediate. This service also requires a lot less financial and human resources to promote the websites and draw traffic. This new ranking model has become quite attractive to e-commerce marketers and many search engines are rushing to adopt the model.

While the Pay-To-Placement ranking model makes the job of on-line advertisers a lot easier, it draws quite vociferous criticism from general users. This model usually shows only the websites paying to be listed, and does not have a natural way to combine the results obtained from the full set of Web pages covering the entire Web.

Even when results from both databases are used, the Pay-To-Placement model disregards the objective ranking determined by objective relevancy analysis and lists the paid listings ahead of any non-paid Web page regardless of their relative relevancy. This is somewhat inevitable since most of the Pay-For-Placement models tie the monetary values directly to the placement in the search results.

Consequently, the end-users have no input on the final ranking, and are forced to work with the limited number of websites that paid for promotion. They may find that the result set contains too small a number of Web pages, and the pages listed in the top ranked places are not really relevant to the search other than the fact that someone is paying more money than anyone else for them to be listed there.

Thus, there is a need for a ranking model that allows both the end-users and Web site advertisers to contribute in modifying the ranking of the search results. The Web site advertisers that want to promote their websites need to have a clear and straightforward way to enhance the ranking of their websites in the search results. Just like for any advertisement on any medium, better locations are more expensive than less desirable locations.

The end users of search engines, who are the target audience of the promotion through search result placement, need to have a clear and straightforward way to express their endorsement or approval to websites they find relevant and useful. The end users sometimes want to express their disapproval for the sites they find less helpful or irrelevant.

There also is a need for a method to naturally incorporate these different kinds of positive and negative factors into the ranking algorithm that eventually determines the final placement in the search results, especially in combining the search results from the list of paid websites and the results from the search engines with bigger coverage that are ordered by an objective relevancy analysis without monetary bias.

### SUMMARY OF THE INVENTION

The present invention provides a method and apparatus that modifies the ranking of the search results output by a Web search service by combining a ranking score obtained using an objective relevancy analysis with the number of votes cast by end-users and advertisers.

A method of operating a Web search service in accordance with the present invention includes the steps of receiving one or more search terms, and searching a first database to identify a first list of uniform resource locators (URLs) defined by the search terms. Each URL in the first list has a first score that is defined by a monetary value paid to the Web search service. The first list of URLs is not ordered by the first score.

In addition, the method of the present invention also includes the step of searching a second database to identify a second list of URLs defined by the search terms. Each URL in the second list has a second score that is not defined by a monetary value paid to the Web search service.

The method also includes the step of forming a third list of URLs from the first list of URLs and the second list of URLs. Further, the method includes the steps of determining a calculated score for each URL in the third list of URLs, and ranking the third list of URLs based on the calculated score. The calculated score is defined by the first score and the second score.

The present invention also includes a Web search service that includes means for receiving one or more search terms, and means for searching a first database to identify a first list of uniform resource locators (URLs) defined by the search terms. Each URL in the first list has a first score that is defined by a monetary value paid to the Web search service. The first list of URLs is not ordered by the first score.

The search service also includes means for searching a second database to identify a second list of URLs defined by the search terms. Each URL in the second list has a second score that is not defined by a monetary value paid to the Web search service.

In addition, the service also includes means for forming a third list of URLs from the first list of URLs and the second list of URLs. Further, the service includes means for determining a calculated score for each URL in the third list of URLs, and means for ranking the third list of URLs based on the calculated score. The calculated score is defined by the first score and the second score.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block-diagram illustrating a Web site 100 in accordance with the present invention.

FIG. 2 is a block diagram illustrating ranking computer 116 as an example of computers 110, 120, and 122 in accordance with the present invention.

FIG. 3 is a state diagram 300 illustrating the operation of Web site 100 in accordance with the present invention.

FIG. 4 is a screen shot illustrating an account manager page 400 in accordance with the present invention.

FIG. 5 is a screen shot illustrating a cast-your-vote page 500 in accordance with the present invention.

FIG. 6 is a flow chart illustrating a vote casting method 600 in accordance with the present invention.

FIG. 7 is a screen shot illustrating a purchase page 700 in accordance with the present invention.

FIG. 8 is a screen shot illustrating a search page 800 in accordance with the present invention.

FIG. 9 is a flow chart illustrating a method 900 of performing a search in accordance with the present invention.

FIG. 10 is a screen shot illustrating a search results page 1000 in accordance with the present invention.

### DETAILED DESCRIPTION

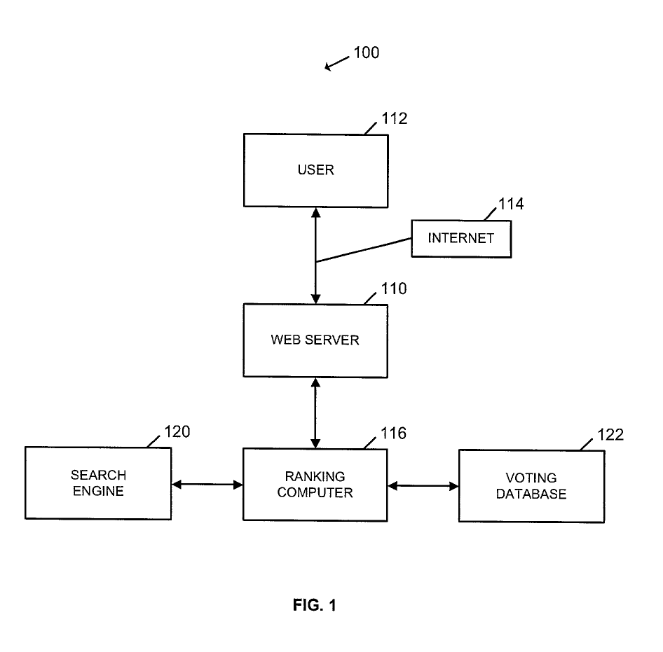

FIG. 1 shows a block-diagram of a Web site 100 in accordance with the present invention. As shown in FIG. 1, Web site 100 includes a Web server 110 that is connectable to a user computer 112 via an Internet connection 114. When connected via the Internet, server 110 receives requests and data from user computer 112, and outputs Web pages and other data to user computer 112.

As further shown in FIG. 1, Web site 100 also includes a ranking computer 116 that is connected to Web server 110. As described in greater detail below, ranking computer 116 performs a ranking algorithm that orders the URLs from a search, from highest to lowest, based on the calculated scores of the URLs.

The calculated score of a URL, in turn, is defined by combining a relevancy score obtained from the search engine using an objective relevancy analysis with a vote score that is based on the number of votes that have been cast for the Web site. The vote score, in turn, includes a paid vote score that is based on the number of paid votes cast for a Web site, a free approval vote score that is based on the number of free approval votes cast for the URL, and a free disapproval vote score that is based on the number of free disapproval votes cast for the URL. Thus, the ranking of a Web site from a search is determined, in part, by the number of votes that have been cast for the Web site.

Any user of Web site 100 can obtain and cast votes. Free votes can be obtained in various ways. The administrators of the voting system, usually portals, can choose to give out a predetermined amount of free votes as rewards for many of the beneficial activities performed by the users on their site. These activities include, for example, login, registration, submitting queries, or clicking on one of the hyperlinks on their web pages or search results.

Free votes can be cast as free approval votes that are used to determine the free approval vote score, or as free disapproval votes that are used to determine the free disapproval vote score. In one embodiment, clicks on URLs in the search results by the user can be interpreted to be an endorsement such that a predetermined amount of free approval votes, typically one, are awarded to the URL for each click.

In addition, users can purchase any desired amount of paid votes for a predetermined monetary value per vote per preset period of time. Paid votes cast for a URL are used to determine the monetary score for the URL. Since the ranking of a Web site in the search results is determined, in part, by the number of paid and free votes that have been cast for the Web site, the more votes that are earned and/or purchased, and then cast for the Web site, the higher the ranking the Web site is able to obtain.

Web site 100 further includes a search engine and Web database computer 120 connected to ranking computer 116 that provides the basic search results for a given set of search terms. The search engine can be either a crawler based or a directory based search engine. The exact nature of the search engine is not essential to the present invention. In a preferred embodiment, the search engine provides a list of URLs ordered by the ranking scores obtained by employing an objective relevancy analysis in response to a given set of search terms.

Web site 100 additionally includes a voting database computer 122 connected to ranking computer 116 that provides the database that maintains necessary data for administering the voting system, i.e., keeping a record of the votes held by each user, and the votes received by a Web site. The voting system database can be implemented with, for example, Microsoft SQL Server 2000 database system, although other database systems such as Oracle, IBM, or other database systems can alternately be used. Some of the data maintained by the database include the list of registered queries, the list of URLs associated with the queries, and the number of votes assigned to each URL.

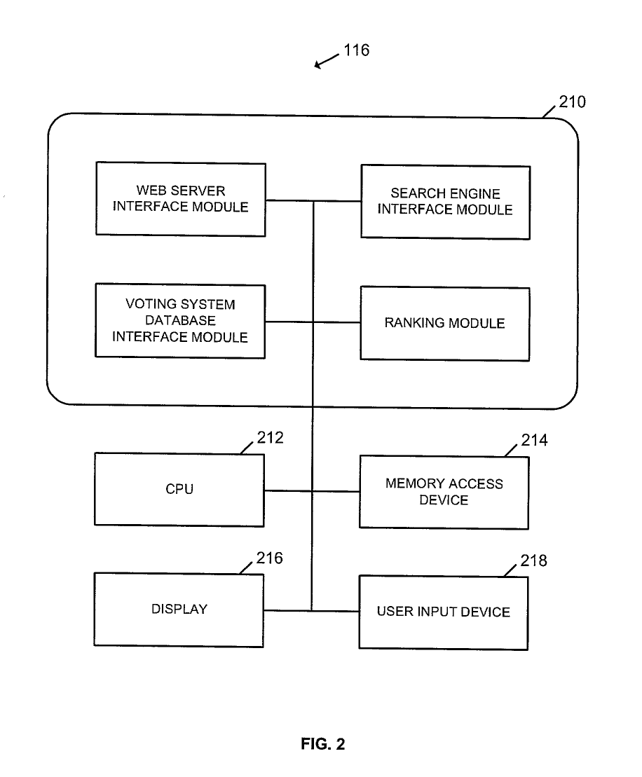

Computers 110, 116, 120, and 122 each have a memory, a central processing unit (CPU), a memory access device, such as a disk drive or a networking card, a display system, and a user-input device, such as a keyboard and a pointing device. FIG. 2 shows a block diagram of ranking computer 116 as an example of computers 110, 120, and 122 in accordance with the present invention.

As shown in FIG. 2, ranking computer 116 includes a memory 210 that has an operating system block that stores an operating system, a program instruction block that stores program instructions, and a data block that stores data. The operating system can be implemented with, for example, the Microsoft 2000 Server operating system, although other operating systems such as Solaris or Linux can alternately be used. The program instructions can be written, for example, in C++ although other languages can alternately be used.

In ranking computer 116, the program instruction block has four main modules: a Web server interface module, a search engine interface module, a voting system database interface module, and a ranking module. The Web server interface module allows ranking computer 116 to interface with Web server 110 which, in turn, handles the interaction with users and the system administrator.

Although Web site 100 has been described in terms of server 110 and ranking computer 116, the program instruction block of ranking computer 116 can alternately include the Web server module. The Web server module is the code required to implement the functions performed by server 110 so that ranking computer 116 can perform these functions directly. This may be appropriate when the number of concurrent users is small.

The search engine interface module allows ranking computer 116 to communicate with search engine and Web database computer 120. Search engine and Web database computer 120 provides the basic search results for a given set of search terms. Alternately, the program instruction block of ranking computer 116 can include the search engine module so that ranking computer 116 can perform the search directly. This may be appropriate when the document set handled by the search engine is small.

The voting system database interface module allows ranking computer 116 to communicate with database computer 122. Database computer 122, in turn, has the database that maintains data regarding the number of votes held by each user, and the number of votes cast of the Web sites. Alternately, the program instruction block of ranking computer 116 can include the database module so that ranking computer 116 can maintain the database directly. This may be appropriate when the number of registered queries and the number of concurrent users is small.

The ranking module implements the specific ranking algorithm that combines the original rank returned by the search engine using an objective relevancy analysis and the number of votes received from the voting system database to determine new ranking scores in which the URLs in the search results will be sorted.

As further shown in FIG. 1, ranking computer 116 also includes a central processing unit (CPU) 212 that is connected to memory 210. CPU 212, which can be implemented with, for example, a Pentium processor, controls the interaction between the internal components of the entire system in response to the program instructions and the data. Although only one processor is described, the present invention can be implemented with multiple processors in parallel to increase the capacity to process large number of concurrent users and large amount of data.

Further, ranking computer 116 includes a memory access device 214, such as a disk drive or a networking card, which is connected to memory 210 and CPU 212. Memory access device 214 allows the program instructions to be transferred to memory 210 from an external medium, such as a disk or a networked computer. In addition, device 214 allows the constructed search results in memory 210 or CPU 212 to be transferred to the external medium.

Ranking computer 116 can further include a display system 216 that is connected to CPU 212. Display system 216 displays images to the users and administrators of the system to help monitoring the progress of the program. Computer 116 also includes a user-input device 218, such as a keyboard and a pointing device, which is connected to CPU 212. The users and administrators operates input device 218 to interact with the program.

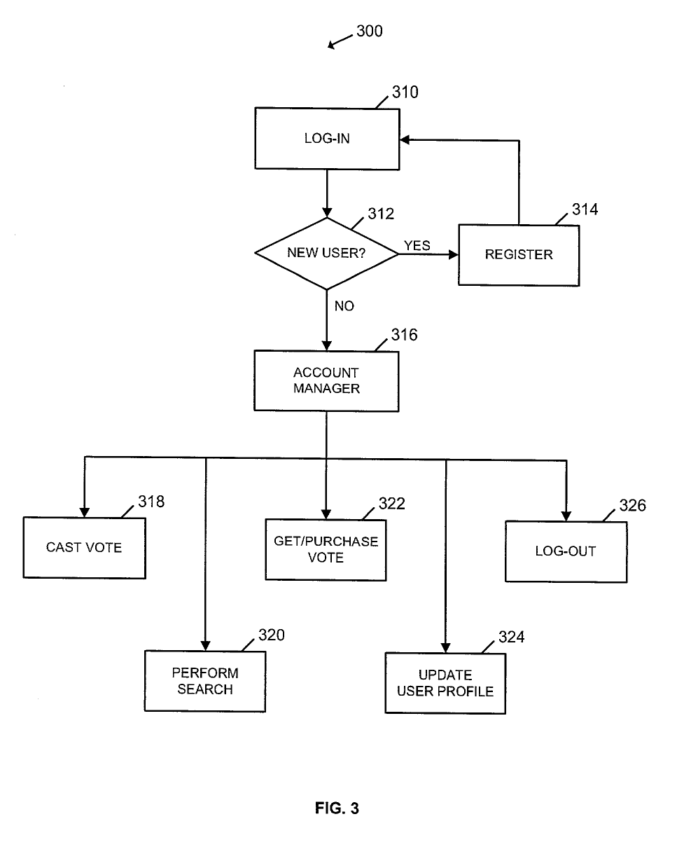

FIG. 3 shows a state diagram 300 that illustrates the operation of Web site 100 in accordance with the present invention. As shown in FIG. 3, operation begins in state 310 where Web server 110 outputs a log-in screen to a user who has entered the URL (Web address) of Web site 100 into their browser.

The log-in screen accepts user data, such as usernames and passwords, to allow the user to log in to the Web site. In addition, anonymous users can be given access to the Web site. Administrators, usually Web portals, can choose to give these anonymous users somewhat limited access to the site, and maintain a collective profile rather than an individual user profile.

Once the log-in data has been provided, operation moves to state 312 to determine if the user is registered. If the user is not registered, operation moves to state 314 to register the user. Registration can be minimal, asking only for information necessary to maintain a user profile, such as username, password, and email address. Administrators, however, can choose to ask for more information, such as the user's state of residence or field of employment. In the embodiment where anonymous users are allowed to have access, the registration step can be skipped for that class of users.

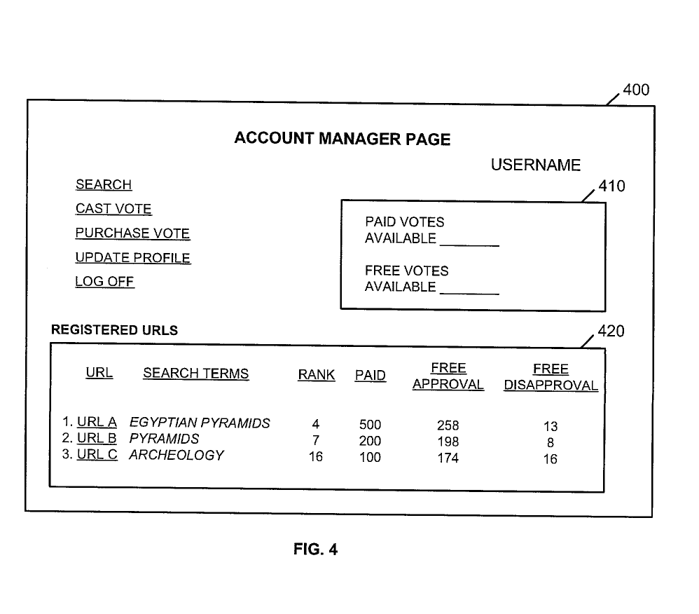

When the user is registered, operation moves to state 316 where Web server 110 outputs an account manager page to the user. (Although FIG. 3 shows operation moving from state 314 to state 310, operation can alternately move from state 314 to state 316.) FIG. 4 shows a screen shot that illustrates an account manager page 400 in accordance with the present invention.

As shown in FIG. 4, account manager page 400 includes links to the other pages that are available to the user, such as cast vote and search. In addition, as further shown in FIG. 4, page 400 includes a votes available display 410 that indicates the number of paid and free votes that the user has available to cast.

Page 400 also includes a display 420 that shows the list of registered URLs the user maintains. Each entry can include the search terms associated with the URL, the current ranking of the URL, the number of paid votes assigned to the URL, the number of free approval votes assigned to the URL, and the number of free disapproval votes assigned to the URL. (Account manager page 400 can include numerous other features in addition to those described with respect to the present invention.)

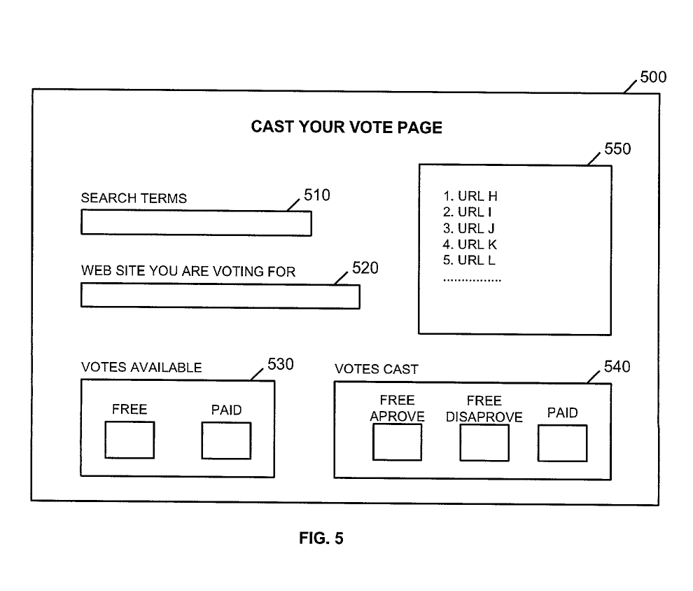

When a user chooses to cast a vote from account manager page 400, operation moves to state 318 where Web server 110 outputs a cast-your-vote page to the user. FIG. 5 shows a screen shot that illustrates a cast-your-vote page 500 in accordance with the present invention.

As shown in FIG. 5, cast-your-vote page 500 includes a data input device 510 that receives a number of search terms. In the present invention, a Web site can only receive votes with respect to a number of search terms. For example, if a user entered the search terms “Egyptian pyramids,” the user can vote for a Web site identified by the search, or a Web site that was not identified by the search. When a user votes for a Web site not identified by the search, the Web site will appear in the search results the next time the search terms are used.

In the present invention, a general user can submit free and/or paid votes to indicate, for example, approval of a particular Web site (or negative free votes to indicate disapproval). In addition, the owner or representative of a particular Web site can also improve the ranking of the Web site in the search results by submitting free and paid votes. After a sufficient number of votes have been obtained, the Web site will increase its ranking the next time the search terms are used.

As further shown in FIG. 5, cast-your-vote page 500 also includes a data input device 520 that receives the URL of the to-be-voted-for Web site. Further, a vote display 530 indicates the number of paid and free votes that are available to the user, and a votes cast display 540 indicates the number of paid votes, free approval votes, and free disapproval votes that have been cast. Cast-your-vote page 500 additionally includes a search results window 550 where the results of a search are displayed.

In the present invention, a minimum number of paid votes is required to qualify a Web site to receive paid votes. Thus, a user must purchase and cast a minimum number of paid votes to register the Web site to receive additional paid votes in the future. (Presumably the owner or a representative of a Web site will register the Web site, although other users may also register a Web site to receive paid votes) The present invention does not allow users to register new Web pages without endorsing them with paid votes.

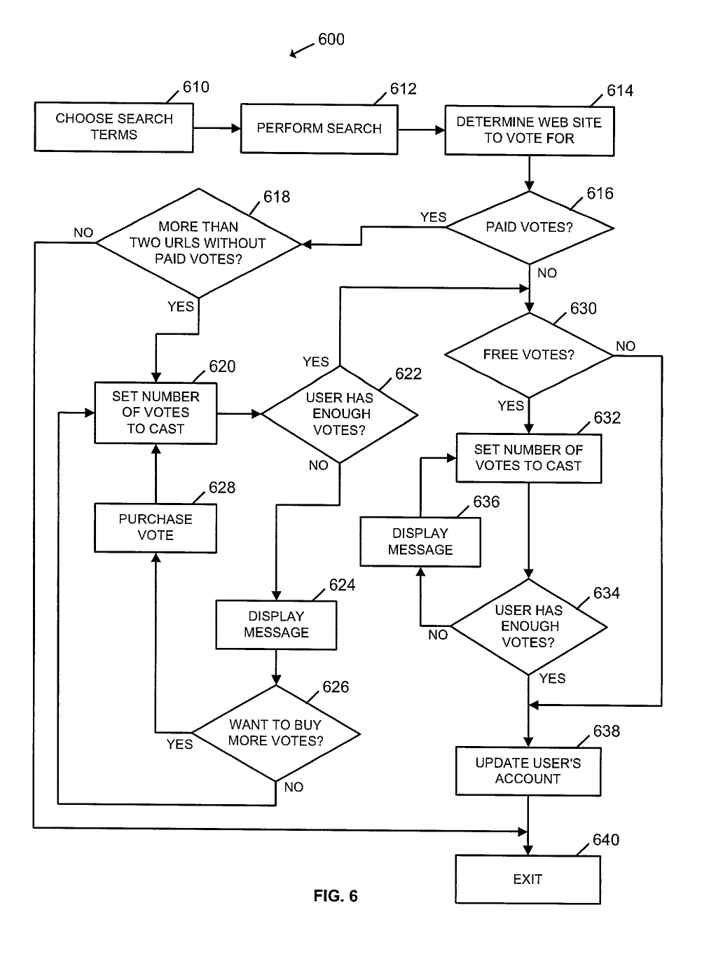

FIG. 6 shows a flow chart of a vote casting method 600 in accordance with the present invention. Method 600 is implemented in software that is programmed into Web server 110. As shown in FIG. 6, method 600 begins at step 610 by asking the user to insert data into data input device 510 to choose search terms.

When device 510 receives the search terms, method 600 moves to step 612 to perform the search. In addition, method 600 also shows the current standing of the Web sites for that particular set of search terms in results window 550 as a list of URLs ordered by ranking scores calculated by ranking computer 116. (A method for performing the search is described below.)

Once the results have been displayed in window 550, method 600 next moves to step 614 to determine the Web site the user wishes to vote for. The user can highlight a URL from the list in results window 550 to cause the URL to be input into data input device 520, or can type a URL into device 520 in case the URL is hard to find or is not in the search result at all.

Once device 520 has received the URL of the Web site to receive a vote, method 600 next moves to step 616 to determine if the user is going to cast a paid vote. If a paid vote is to be cast, method 600 moves to step 618 to determine if there are at least two URLs representing Web pages that have no paid votes in the search result (other numbers greater than two can alternately serve as the minimum number of URLs that have no paid votes). If there are fewer than two URLs in the search results with no paid votes, method 600 moves to step 640 to exit from the casting vote process and return to the account manager page 400.

There are two main cases that can cause the test in step 618 to fail. The first case is that the scope of the search terms entered in step 610 is very narrow and there are less than three Web sites in the search results. The other possibility is that most of the Web sites in the search result have already received paid votes and only two Web sites remain with no paid votes.

The purpose of the test in step 618 is to ensure that there are always at least two Web sites without paid votes in the search results. This restriction effectively prohibits users from registering any new Web page when there is only one or zero Web page in the current search result.

All Web pages that are not in the list returned by the search engine, but are in the list returned by the voting database, are guaranteed to have at least the minimum number of paid votes if the Web sites have any paid votes at all. This, in turn, ensures that the search results produced by the present invention are not totally dominated by the paid votes and a minimum level of quality is maintained. Consequently, the search results from the voting database are never ranked in the order of paid votes or by the monetary scores.

When there are more than two Web sites without a paid vote, method 600 moves to step 620 to determine the number of paid votes that the user wishes to cast. In one embodiment, method 600 can provides a selection box that offers the user several different choices of preset number of votes. Next, method 600 moves to step 622 to determine if the user has enough votes to perform this transaction.

If the user does not have enough paid votes, method 600 moves to step 624 to display the message “Not Enough Paid Votes Available.” Method 600 then moves to step 626 to determine whether the user wishes to adjust the number of paid votes or purchase additional votes. If the user wishes to adjust the number of votes, method 600 returns to step 620. On the other hand, if the user wishes to purchase additional votes, method 600 moves to step 628 to go to a purchase page.

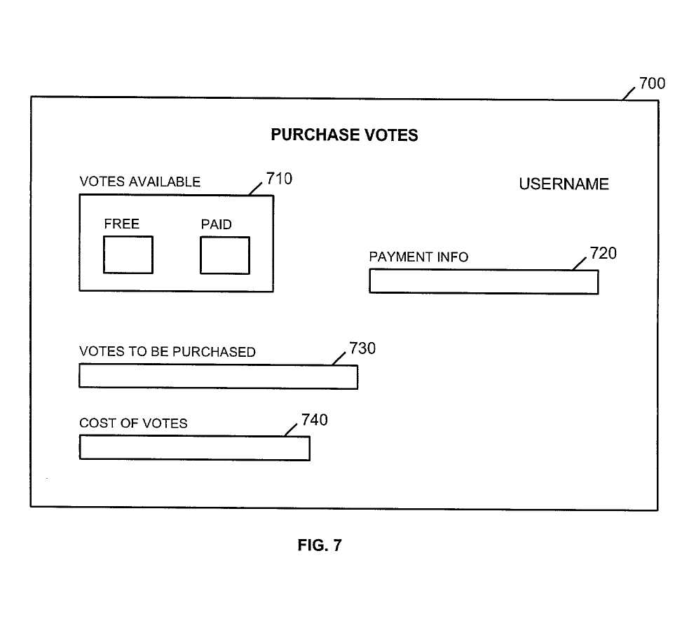

FIG. 7 shows a screen shot of a purchase page 700 in accordance with the present invention. As shown in FIG. 7, purchase page 700 includes a votes available display 710 that indicates how many paid and free votes are available to a user, and a transaction input device 720 that receives credit card or other payment information. In addition, purchase page 700 also includes a votes purchase input device 730 that indicates the number of votes to be purchased. Further, purchase page 700 includes a cost of votes display 740.

Returning to FIG. 6, once additional votes have been purchased, method 600 returns to step 620, and iterates until the user obtains enough votes to carry out the transaction or lowers the number of votes to be cast. When paid votes have been cast and the user has enough votes, or if no paid votes have been cast at all, method 600 moves from step 622 or step 616 to step 630 to determine if the user wishes to cast free votes. If no free votes are to be cast, method 600 moves to step 638 to update the user's account.

When the user wishes to cast free votes, method 600 moves to step 632 to set the number of free votes to cast. The user can cast free votes as free approval votes that are used to determine the free approval vote score, or as free disapproval votes that are used to determine the free disapproval vote score.

In one embodiment, method 600 can provides a selection box that offers user several different choices of preset number of votes. The selection can include negative votes (free disapproval votes) in case the user finds a particular Web site is irrelevant or of poor quality for the given search terms and wishes to express disapproval to demote its ranking. Negative votes are not allowed for paid votes to prevent malicious votes against competitors.

Following this, method 600 moves to step 634 to determine if the user has enough free votes to perform this transaction. If the user does not have enough free votes, method 600 moves to step 636 to display the message “Not Enough Free Votes Available.” Method 600 then moves to step 632 to allow the user the opportunity to adjust the number of free votes to cast.

When the user has enough free votes, or if no free votes are to be cast, method 600 moves to step 638 to complete the voting request and update the user's account reflecting the recent vote casting and subtracting that amount from the user's balance.

In step 638, the number of paid votes are added to the total number of paid votes accumulated by the URL, the number of free approval votes are added to the total number of free approval votes accumulated by the URL, and the number of free disapproval votes are added to the total number of free disapproval votes accumulated by the URL. In step 640, method 600 exits and returns to account manager page 400.

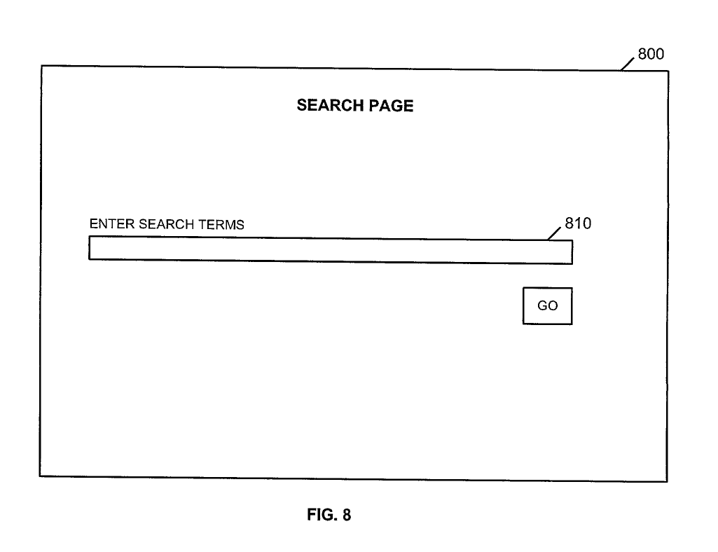

In addition to choosing to cast a vote from account manager page 400, the user can alternately choose perform a search. When the user chooses to perform a search, operation moves to state 320 where Web server 110 outputs a search page to the user. FIG. 8 shows a screen shot that illustrates a search page 800 in accordance with the present invention. As shown in FIG. 8, search page 800 includes a data input device 810 for inputting search criteria. Once the search criteria have been input, Web server 110 passes on the search criteria to ranking computer 116 to perform a search.

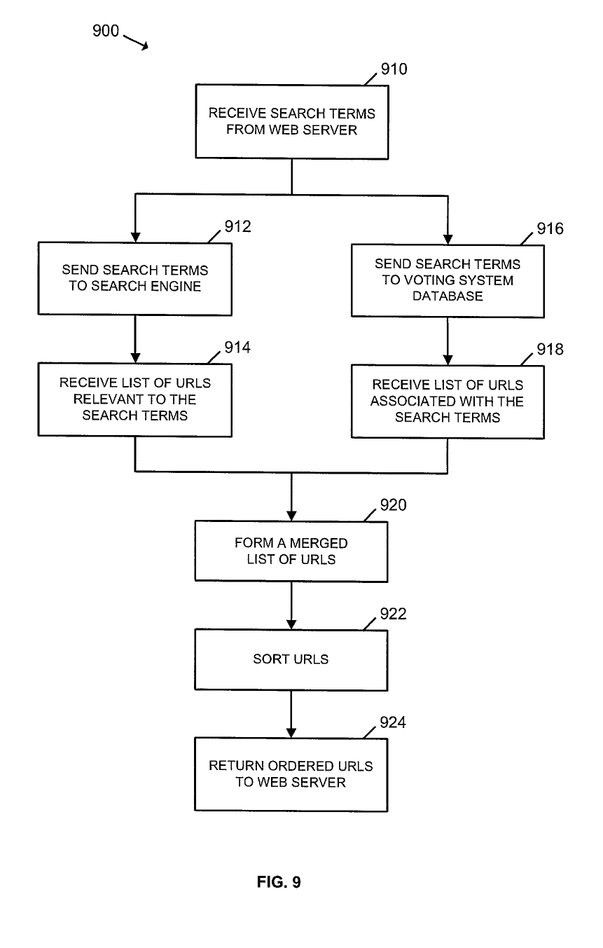

FIG. 9 shows a flow chart that illustrates a method 900 of performing a search in accordance with the present invention. Method 900 is implemented in software that is programmed into ranking computer 116. As shown in FIG. 9, method 900 begins at step 910 by receiving search terms from Web server 110 through the interface module.

Once the search terms are received from Web server 110, method 900 branches and moves simultaneously to steps 912 and 916. (Method 900 can alternately perform the steps serially, e.g., steps 912, 914, 916, and 918; or steps 916, 918, 912, and 914.) In step 912, method 900 sends the search terms to search engine and Web database computer 120 through the search engine interface module. In some cases, method 900 may need to modify the syntax of the original search terms to conform to the one used by the particular search engine utilized for the search.

In step 914, method 900 receives the list of URLs relevant to the search terms from the search engine in response to the search. Each URL in the list has a ranking score that determines the URL's rank in the list. Method 900 assigns a rank to each URL in the list based on the ranking score. For example the URL in the list with the highest ranking score gets the number 1 rank while and the URL with the second highest ranking score gets the number 2 rank and so forth.

In step 916, method 900 sends the search terms to voting system database 122 via the voting system database interface. In step 918, method 900 receives the list of URLs representing the Web pages associated with the search terms from the voting system database. Each URL in the list has a total number of paid votes that represents the number of paid votes that have been purchased and cast for the URL. The URLs in the list, however, are not ordered by the number of paid votes where the first URL in the list has received the most paid votes. Rather, the list of URLs output from database 122 is in a non-paid vote order, such as an alphabetical order or registration date order.

In addition to the total number of paid votes, the data returned from database 122 also contains the total number of free approval and disapproval votes each URL has accumulated. (In one embodiment, voting system database 122 only returns the number of paid votes.) The administrator of the voting system can assign different weighting factors in determining the final ranking of the search results.

In step 920, method 900 forms a merged list of URLs using the list of URLs from the search engine and the list of URLs from the voting database. For example, the merged list of URLs can be formed by adding each URL from the search engine to the merged list of URLs. For each URL in the list of URLs from the voting database, method 900 determines if a corresponding URL is present in the merged list of URLs.

When a corresponding URL is present in the merged list of URLs, method 900 assigns the total number of paid votes, free approval votes, and free disapproval votes to the corresponding URL in the merged list so that the corresponding URL in the merged list has a rank or a ranking score, a paid vote total, a free approval vote total, and a free disapproval vote total. On the other hand, when a corresponding URL is not present in the merged list of URLs, method 900 adds the URL from the voting database to the merged list of URLs.

Method 900 determines if a corresponding URL is present in the merged list of URLs by using, for example, a straightforward string match. In another embodiment, this comparison can be done in more elaborate ways to recognize the common variations in URLs. For example, the URLs http://www.microsoft.com and http://microsoft.com locate exactly the same content and should be considered as identical URLs. The URLs http://www.yahoo.com and http://www.yahoo.com/index.html also retrieve the same content and should be considered as identical URLs.

Once the merged list of URLs have been formed, method 900 moves to step 922 to determine a calculated score for each URL in the list, and rank the URLs according to their calculated scores. Method 900 can determine a calculated score for a URL in a number of ways.

For example, method 900 can determine a calculated score by multiplying the ranking score times a factor to form a relevancy score, multiplying the paid vote total times a factor to form a monetary score, multiplying the free approval vote total times a factor to form a free approval vote score, multiplying the free disapproval vote total times a factor to form a free disapproval vote score, and then summing the scores together.

As another example, method 900 can employ the following formula to obtain the calculated scores:

S(i)=α·ƒ(R(i))+Nₚ(i)+β·Nₐ(i)−γ·N_{d}(i0.

Here S(i) denotes the calculated score of the i-th URL while R(i) represents the original rank of that URL in the list returned by search engine computer 120. If the URL is not in the list returned by the search engine, usually assigning a big number as the original rank works well. The adjustable parameters α, β and γ have constant values. Nₚ(i) represents the number of paid votes accumulated for the i-th URL (the number of paid votes defining the monetary score). Nₐ(i) represents the number of free approval votes accumulated for it, while N_{d}(i) denotes the number of free disapproval votes accumulated against the i-th URL.

The function ƒ(i) represents a monotonically decreasing function for its argument. One example of such function can be:

ƒ(i)=11−i for i≦10 and ƒ(i)=0 for i>10.

The constant parameter α, combined with the function η(i) determines how the original rank is converted to an equivalent number of votes that defines the relevancy score. For example, if the administrator chooses the constant parameter α to be 10 and uses the function ƒ(i) as defined above, the top URL returned by the search engine can be considered as having 100 additional paid votes or a relevancy score of 100. The role of the constant parameter β is to adjust the relative importance of free approval votes to the paid votes. The value 0.1 for the parameter β, for example, means that ten free approval votes are equivalent to one paid vote. The constant parameter γ is to set the relative importance of free disapproval votes to the paid votes. The value 0.1 for the parameter γ, for example, means that ten free disapproval votes can nullify one paid vote.

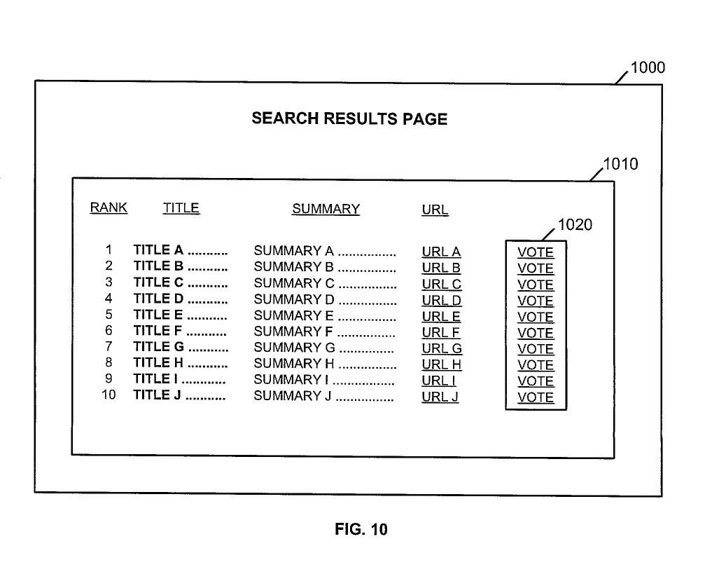

After determining the calculated scores for all the URLs in the merged list, method 900 sorts them in the descending order of the calculated scores. In step 924, method 900 returns the ordered URLs to Web server 110. FIG. 10 shows a screen shot that illustrates a search results page 1000 in accordance with the present invention. As shown in FIG. 10, search page 1000 includes a list of search results 1010 that have been ordered in the manner just described.

As further shown in FIG. 10, each entry in the list of search results 1010 represents a Web site and includes information such as its current ranking, title, and URL. Each entry also includes a voting button 1020. In operation, when a user clicks on voting button 1020, cast-your-vote page 500 is displayed. In this case, the search terms are automatically inserted into input device 510, and the URL from the search results page the voting button is associated with is automatically inserted into input device 520.

Thus, voting button 1020 simplifies the voting process for the average user in that the user can simply select a URL and click on the voting button associated with it. In addition, voting button 1020 can also be a floating button that appears on a number of the Web pages from a search-linked Web site. This allows a user to vote for a Web site without having to return to the search page.

From account manager page 400, the user can also choose to move to state 322 where purchase page 700 is output to the user. The user can further choose to move to state 324 where the user can modify their user profiles. Users can, for example, change their passwords, email addresses, and other optional parameters and settings. Finally, the user can choose to move to state 326 to log out. Web server 110 can perform clean-up process at this point. The process can include saving the user's last search terms and its results and so forth.

It should be understood that various alternatives to the method of the invention described herein might be employed in practicing the invention. Thus, it is intended that the following claims define the scope of the invention and that methods and structures within the scope of these claims and their equivalents be covered thereby.

What is claimed is:

1. A method of operating a Web search service, the method comprising the steps of:
receiving one or more search terms;
searching a first database to identify a first list of uniform resource locators (URLs) representing Web pages defined by the search terms, each URL in the first list having a first score, the first score being defined by a monetary value paid to the Web search service, the first list of URLs not being ordered by the first score;
searching a second database to identify a second list of URLs defined by the search terms, each URL in the second list having a second score, the second score not being defined by a monetary value paid to the Web search service;
forming a third list of URLs from the first list of URLs and the second list of URLs;
determining a calculated score for each URL in the third list of URLs, the calculated score being defined by the first score and the second score; and
ranking the third list of URLs based on the calculated score.

2. The method of claim 1 and further comprising the steps of:
selling a number of paid votes to a user;
receiving an indicator that identifies a URL selected to receive a number of paid votes;
determining if the third list of URLs has at least two URLs with no first score;
adding the number of paid votes to the first score of the URL selected to receive the number of votes only when the third list of URLs has more than two URLs with no first score.

3. The method of claim 2 wherein the calculated score is determined by multiplying the first score times a first weighting factor to form a first weighted score, multiplying the second score times a second weighting factor to form a second weighted score, and adding the first weighted score to the second weighted score.

4. The method of claim 1 and further comprising the steps of:
selling a number of paid votes to a user;
assigning a number of free votes to the user;
receiving an indicator that identifies a URL selected to receive a number of votes; and
determining if the user wishes to cast paid votes, free votes, or both paid votes and free votes.

5. The method of claim 4 and further comprising the steps of:
when paid votes are to be cast, determining if the third list of URLs has more than two URLs with no first score; and
adding the number of paid votes to the first score of the URL selected to receive the number of votes only when the third list of URLs has more than two URLs with no first score.

6. The method of claim 5 wherein each entry in the first list of URLs also includes a third score, the third score being defined by a number of cast free votes.

7. The method of claim 6 and further comprising the step of, when a number of free votes are to be cast for a URL, adding the number of free votes to the third score of the URL selected to receive the number of free votes.

8. The method of claim 7 wherein the calculated score is determined by multiplying the first score times a first weighting factor to form a first weighted score, multiplying the second score times a second weighting factor to form a second weighted score, multiplying the third score times a third weighting factor to form a third weighted score, and adding the first weighted score, the second weighted score, and the third weighted score.

9. The method of claim 5 wherein each entry in the first list of URLs also includes a third score and a fourth score, the third score being defined by free votes cast in approval, the fourth score being defined by free votes cast in disapproval.

10. The method of claim 9 and further comprising the step of, when a number of free votes are to be cast for a URL, adding free votes cast in approval to the third score of the URL selected to receive the number of free approval votes, and adding free votes cast in disapproval to the fourth score of the URL selected to receive the number of free disapproval votes.

11. The method of claim 10 wherein the calculated score is determined by multiplying the first score times a first weighting factor to form a first weighted score, multiplying the second score times a second weighting factor to form a second weighted score, multiplying the third score times a third weighting factor to form a third weighted score, multiplying the fourth score times a fourth weighting factor to form a fourth weighted score, and adding the first weighted score, the second weighted score, the third weighted score, and the fourth weighted score.

12. The method of claim 1 wherein the step of forming the third list of URLs includes:
adding each URL in the second list of URLs to the third list of URLs;
for each URL in the first list of URLs, determining if a corresponding URL is present in the third list of URLs;
when a corresponding URL is present in the third list of URLs, assigning the first score to the corresponding URL in the third list so that the corresponding URL in the third list has both a first score and a second score; and
when a corresponding URL is not present in the third list of URLs, add the URL from the first list of URLs to the third list of URLs.

13. The method of claim 12 wherein a corresponding URL is present if a URL from the first list of URLs and a URL from the second list of URLs cause a same Web page to be displayed.

14. The method of claim 1 wherein the calculated score is determined by multiplying the first score times a first weighting factor to form a first weighted score, multiplying the second score times a second weighting factor to form a second weighted score, and adding the first weighted score to the second weighted score.

15. The method of claim 2 wherein the URL selected to receive a number of paid votes is absent from the third list.

16. The method of claim 2 wherein the URL selected to receive a number of paid votes is present in the third list.

17. The method of claim 1 wherein the second list is ordered according to the second score.

18. The method of claim 4 wherein free votes are added to the third score of a URL in the third list when a user clicks on the URL in the third list.

19. A Web search service comprising:
means for receiving one or more search terms;
means for searching a first database to identify a first list of uniform resource locators (URLs) representing Web pages defined by the search terms, each URL in the first list having a first score, the first score being defined by a monetary value paid to the Web search service, the first list of URLs not being ordered by the first score;
means for searching a second database to identify a second list of URLs defined by the search terms, each URL in the second list having a second score, the second score not being defined by a monetary value paid to the Web search service;
means for forming a third list of URLs from the first list of URLs and the second list of URLs;
means for determining a calculated score for each URL in the third list of URLs, the calculated score being defined by the first score and the second score; and
means for ranking the third list of URLs based on the calculated score.
